(19) United States
(12) Patent Application Publication
(10) Pub. No.: US 2011/0000804 A1
(43) Pub. Date: Jan. 6, 2011

(54) Storage device for a data carrier

(76) Inventor: Tino Solling, Taastrup (DK)

Correspondence Address: Dykema Gossett PLLC, Suite 300 West, 1300 I Street N.W., Washington, DC, 20005-3306, US

(21) Appl. No.: 12/923,220

(22) Filed: Sep. 9, 2010

Related U.S. Application Data
(63) Continuation of application No. 11/921,164, filed on Nov. 28, 2007, now abandoned.

(30) Foreign Application Priority Data
Oct. 10, 2005 (DK) PA 2005 01412

(51) Int. Cl. B65D 85/57; B29C 45/14

(52) U.S. Cl. 206/308.1; 264/250

(57) ABSTRACT

A storage device includes a rear element and a front element; where in at least one of the rear or the front element at least one holding means is provided for holding a data carrier in a releasable manner, where the storage device includes first material and further in engagement areas includes a second material with friction characteristics different from the friction characteristics of the first material. Hereby improved handling and engagement characteristics are obtained.

### BACKGROUND OF THE INVENTION

Data carriers of the type relevant for the present invention comprise a carrier surface having a circular outer circumference. The data carrier comprises a central hole. Such data carrier is used for storage of various sorts of data, primarily digital data. Examples of such data carriers are CD's and DVD's, e.g. for music storage, for data program storage, for game storage or for movie storage. The discs typically have the same physical dimensions, however this is not always the case and for the purpose of the present invention the physical dimensions of the data carrier could be any.

For the storage of the data carrier itself various storage devices have been used and described.

One example is the commonly known jewel box, which normally is used for storage of music CD's. This previously known box comprise a rear plate from which a number of arms project upwardly in a circular arrangement.

A further previously known device is disclosed in WO 96/14636. This previously known device features a press and release function, which by means of either the flexibility of flexible ejector elements in a rear element or the flexibility of the disc itself is intended to eject the disc upon applying a pressure on a locking element holding the disc at the central hole.

I still further prior art storage device is disclosed in EP 0356539. This previously known storage device is like the one described above of the type featuring a press and release function. The device is described as a development taking its starting point in a storage device corresponding to the above mentioned jewel box. These previously known devices all relate to storage devices capable of holding a single or even two or more data carriers. A common problem that has been discovered in the practical use of previously known devices is the difficulties in various engagements with the storage device, e.g. the engagement with the front and rear parts of the device when opening the device and further the engagement of the data carrier with the holding means in the device. The ability to ensure an engagement that facilitates the use of the device is therefore a main objective of the present invention.

### SUMMARY OF THE INVENTION

According to the invention this is obtained by means of a storage device as defined in claim 1.

By providing at least one engagement area located in the rear element and the front element opposite the hinge area with friction and/or hardness properties different from other areas of the device an improved handling of the device is ensured.

Preferred embodiments are depicted in the dependent claims.

In claim 2 the holding means constitute an engagement area comprising the second material.

According to the invention this is further obtained by means of a method for manufacturing a storage device as defined in claim 4.

By such process it is ensured that the two materials are mutually interconnected in the manufacturing process and a reliable product may be manufactured.

Preferably this is done in the way depicted in claim 5, where the engagement part of the construction is moulded in the secondary moulding step.

According to the invention the objective of the invention may still further be achieved by means of a method for manufacturing a storage device as defined in claim 6.

As defined in claim 7 there may be different methods for connection of the separate elements of the storage device.

The invention will be described more detailed in connection with the following detailed description of a preferred embodiment with reference to the drawings.

### BRIEF DESCRIPTION OF THE DRAWINGS

FIG. 1 is a perspective view of an embodiment of the storage device according to the invention;

FIG. 2 is a top view of the storage device shown in FIG. 1;

FIG. 3 is sectional view according to the line 3-3 in FIG. 2;

FIG. 4 is sectional view according to the line 4-4 in FIG. 2;

FIG. 5 is a view from an end area of the storage device as shown in FIG. 1.

### DESCRIPTION OF THE PREFERRED EMBODIMENT

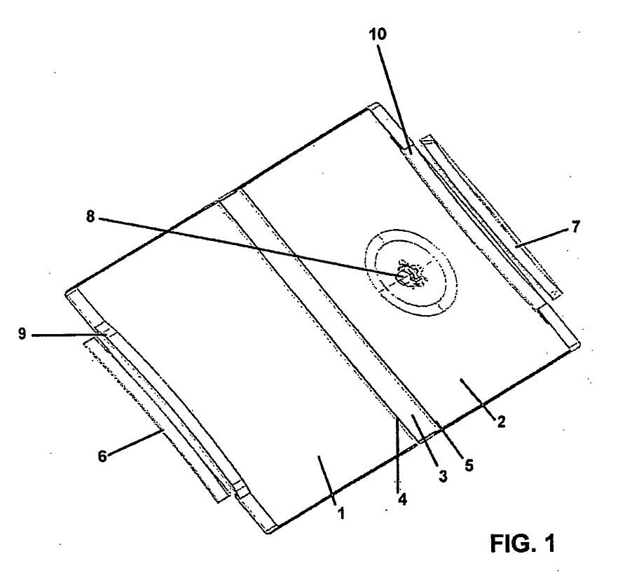

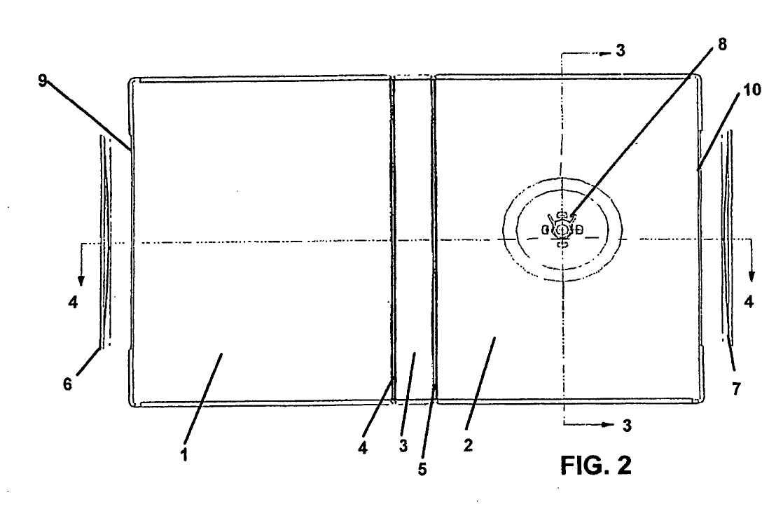

From FIG. 1 a storage device appears in the form of a box comprising a rear element 1 and a front element 2. The rear element and the front element are pivotally connected to a connection element 3 at two hinge areas 4,5 and further comprise means for interlocking the two parts in a releasable manner. In this case only the rear element comprises a data carrier holding means 8; however the rear element 1 and a front element 2 may each comprise two, i.e. in total four, holding means for holding a corresponding number of data carriers, i.e. one on each holding means. At the sides two panels 6,7 are provided comprising a different material than the front and the element. These panels are mounted on the front element and rear element, respectively, in corresponding recesses or accommodation areas 9,10 in the sides of the front and rear elements 1,2 opposed from the hinge areas 4,5. The recesses or accommodation areas 9,10 are provided in wall elements extending essentially perpendicular from the base parts of the rear and front elements 1,2. In FIGS. 1 and 2 the panels are shown in a state where these are not yet mounted on the front and the rear element. The connection between the front element and the one panel and the rear element and the other panel may be through a mechanical connection, such as a snap locking connection, or through an adhesive connection.

By providing the panels 6,7 comprising a second material with a different friction coefficient and/or a softer texture the handling of the storage device can be improved by that the opening and closing of the storage device is done more easily than by previously known similar storage devices. The second material may advantageously be a soft rubber like polymer or plastic material.

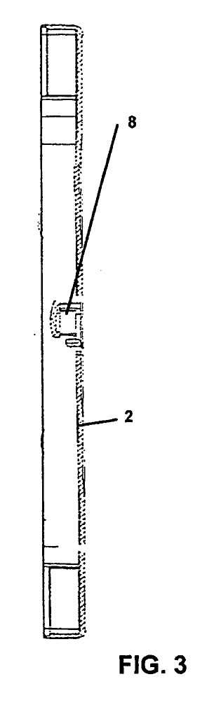

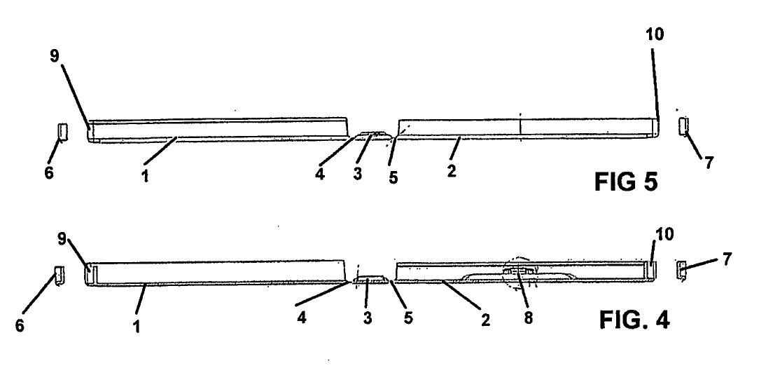

In FIG. 3 and FIG. 4 the storage device is shown in sectional views along lines 3-3 and 4-4, respectively, in FIG. 2. From FIG. 3 the holding means appear more clearly. The holding means may comprise a second material with friction and/or hardness characteristics different from the first material In order to improve handling of the storage device, especially the handling carried out during removal and insertion of a data carrier. From FIG. 4 the various elements appearing in the previous figures are visible.

In FIG. 5 an end view of the storage device appears. The front and rear elements 1 and 2 appear as well as the connection element 3 connected at hinges 4 and 5. The side panels 6,7 appear at the sides of the front and rear elements.

The data carrier holding means 8 provided may for the purpose of this invention be of any type, however in order to improve the engagement with these during operation, i.e. during removal or insertion of a data carrier, there may advantageously be provided parts with a second material with a different friction coefficient or be of a softer material than the surrounding material hereby improving the handling of the storage device further.

1. A storage device comprising:
a rear element;
a front element;
where the rear element and the front element are mutually interconnected in a pivotable manner at one side, where in at least one of the rear or the front element at least one holding means is provided for holding a data carrier in a releasable manner, where the storage device comprises a first polymer material and further in engagement areas in the rear element and in the front element, at a side opposite the side of mutually interconnection comprises a second polymer material with friction and/or hardness characteristics different from the friction and/or hardness characteristics of the first material.

2. The storage device according to claim 1, where the engagement areas are separate elements mounted on the front and the rear element.

3. The storage device according to claim 1, where the holding means constitutes an engagement area comprising the second material.

4. A method for manufacturing a storage device according to claim 1, where in a first mould a first part is manufactured from a first material in an injection moulding process and where the second material is applied to the first material in a successive process step.

5. The method according to claim 4, where the first part is transferred to a second mould designed to accommodate the first part and where a second material is injected into the second mould for integral connection with the first material of the first part.

6. The method according to claim 5, where in the second mould space is left in excess of the first part to accommodate the engagement areas comprising the second material.

7. The method of manufacturing a storage device according to claim 1, where a first part comprising the front part and the rear part is provided comprising a first material and at least one second engagement element is provided comprising a second material and where the first part and the engagement element are connected.

8. The method according to claim 7, where the first part and the engagement element are connected by mechanical snap connection, by adhesive connection or by welding.

9. A storage device comprising:
rear element;
front element;
where the rear element and the front element are mutually interconnected in a pivotable manner at one side, where in at least one of the rear or the front element at least one holding means is provided for holding a data carrier in a releasable manner, where the storage device comprises a first polymer material and further in engagement areas comprises a second polymer material with friction and/or hardness characteristics different from the friction and/or hardness characteristics of the first material.

10. The storage device according to claim 9, where the engagement areas are separate elements mounted on the front and the rear element.

11. The storage device according to claim 9, where the holding means constitutes an engagement area comprising the second material.

12. A method for manufacturing a storage device comprising a first and a second material, where in a first mould a first part is manufactured from a first material in an injection moulding process and where the second material is applied to the first material in a successive process step.

13. The method according to claim 12, where the first part is transferred to a second mould designed to accommodate the first part and where a second material is injected into the second mould for integral connection with the first material of the first part.

14. The method according to claim 13, where in the second mould space is left in excess of the first part to accommodate the engagement areas comprising the second material.

15. A method of manufacturing a storage device comprising two materials, where a first part comprising the front part and the rear part is provided comprising a first material and at least one second engagement element is provided comprising a second material and where the first part and the engagement element are connected.

16. The method according to claim 15, where the first part and the engagement element are connected by mechanical snap connection, by adhesive connection or by welding.
